(19) United States
(12) Patent Application Publication
(10) Pub. No.: US 2009/0226689 A1
(43) Pub. Date: Sep. 10, 2009

(54) PRESSURE SENSITIVE CONDUCTIVE SHEET AND PANEL SWITCH USING THE SAME

(75) Inventors: Hirotoshi Watanabe, Osaka (JP); Yasutaka Yamamoto, Osaka (JP); Koji Tanabe, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/400,192

(22) Filed: Mar. 9, 2009

(30) Foreign Application Priority Data
Mar. 10, 2008 (JP) JP 2008-058940

(51) Int. Cl. B32B 7/02; B32B 5/16

(52) U.S. Cl. 428/212; 428/323

(57) ABSTRACT

A pressure sensitive conductive sheet includes a film-like base material, and a low resistive layer and a high resistive layer, which are formed in this order on the bottom surface of the base material. The high resistive layer has soft particles and hard particles different in average particle size dispersed therein. There are fixed contacts formed under the bottom surface of the high resistive layer. The pressure sensitive conductive sheet and a panel switch using the sheet have small variations in the resistance change after repeated pressing, thereby providing reliable operation.

### BACKGROUND OF THE INVENTION

1. Field of the Invention

The present invention relates to a pressure sensitive conductive sheet and a panel switch using the sheet, which are used to operate various electronic apparatuses.

2. Background Art

In recent years, various electronic apparatuses including portable telephones and car navigation systems are becoming increasingly functional and diverse. In line with this, panel switches used to operate these apparatuses are expected to be diverse and to provide reliable operation.

One such conventional panel switch will be described with reference to FIGS. 6 to 8 and FIGS. 9A and 9B. Of these drawings, the sectional views are exaggerated in the thickness direction for clarity.

FIG. 6 is a sectional view of a conventional panel switch. As shown in FIG. 6, the panel switch includes pressure sensitive conductive sheet 4 having film-like base material 1 and resistive layer 2 formed on the bottom surface of base material 1. Resistive layer 2 is made of a synthetic resin with carbon powder dispersed therein. Resistive layer 2 has different sized particles 3 dispersed therein which are made of a synthetic resin, glass, or the like, so that resistive layer 2 has a rough bottom surface.

The panel switch also includes board 5 on the bottom surface of pressure sensitive conductive sheet 4, board 5 being provided on its top surface with fixed contacts 6A and 6B made of silver, carbon, or the like. Between pressure sensitive conductive sheet 4 and board 5, there is provided spacer 7 which is made of an insulating resin and surrounds fixed contacts 6A and 6B. As a result, the bottom surface of pressure sensitive conductive sheet 4 is opposed to fixed contacts 6A and 6B with a predetermined spacing therebetween.

The panel switch thus structured is installed on the control surface of an electronic apparatus, with fixed contacts 6A and 6B connected to electronic circuits (not shown) of the apparatus via lead wires (not shown) or the like.

FIG. 7 is a sectional view showing a state in which the conventional panel switch is pressed. As shown in FIG. 7, when the user presses the top surface of pressure sensitive conductive sheet 4, pressure sensitive conductive sheet 4 bends downward, so that the portion of the bottom surface of resistive layer 2 that has large particles 3A and 3B is brought into contact with fixed contacts 6A and 6B. As a result, fixed contacts 6A and 6B are electrically connected to each other via resistive layer 2.

When the user applies a higher compressive force, the portion of the bottom surface of resistive layer 2 that has particles 3C and 3D smaller in size than particles 3A and 3B is also brought into contact with fixed contacts 6A and 6B. As a result, resistive layer 2 has a larger contact area with fixed contacts 6A and 6B, thereby changing the resistance between fixed contacts 6A and 6B.

FIG. 8 is a resistance characteristic diagram relative to the compressive force in the conventional panel switch. As shown in FIG. 8, as the compressive force increases, it increases the contact area between fixed contacts 6A and 6B and the bottom surface of resistive layer 2, which is rough because resistive layer 2 contains different sized particles 3. In other words, a small compressive force produces a large resistance, and a large compressive force produces a small resistance. Thus, as shown in the curved line “A” of the resistance characteristic diagram of FIG. 8, the resistance characteristics gradually change according to the compressive force.

The electric connections or the resistance changed according to the compressive force are detected by an electronic circuit so as to perform various functions of the apparatus such as changing the speed of the cursor or the pointer on the display screen. A conventional technique related to the panel switch is disclosed in Japanese Patent Unexamined Publication No. 2008-311208.

FIGS. 9A and 9B are enlarged sectional views showing a state in which the conventional panel switch has been repeatedly pressed.

In the case where particles 3 dispersed in resistive layer 2 are soft and elastically deformable, every time the user presses pressure sensitive conductive sheet 4, the bottom surface of resistive layer 2 is pressed against fixed contacts 6A and 6B. As a result, particles 3 and resistive layer 2 around them are repeatedly elastically deformed. When pressing has been repeated hundreds of thousands or a million times, resistive layer 2A around particles 3 is expanded and deformed as shown in FIG. 9A. The expansion and deformation increases the distance between fixed contacts 6A and 6B, and hence, the same compressive force can produce a larger resistance shown in the curved line “B” than the original resistance shown in the curved line “A” of FIG. 8.

In contrast, in the case where particles 3 are hard and rigid, every time the user presses sensitive conductive sheet 4, the bottom surface of resistive layer 2 is pressed against fixed contacts 6A and 6B by particles 3. When pressing has been repeated, the bottom surface of resistive layer 2B beneath particles 3 becomes almost flat as shown in FIG. 9B. This increases the contact area between the bottom surface of resistive layer 2B and fixed contacts 6A and 6B, possibly causing the same compressive force to produce a smaller resistance as shown in the curved line “C” than the original resistance shown in the curved line “A” of FIG. 8.

Thus, the conventional pressure sensitive conductive sheet and the panel switch using the sheet can cause variations in the resistance change according to the compressive force after pressing has been repeated hundreds of thousands or a million times. Therefore, it is necessary for an electronic circuit to detect the resistance in anticipation of such variations.

### SUMMARY OF THE INVENTION

An object of the present invention is to provide a pressure sensitive conductive sheet and a panel switch using the sheet which have small variations in resistance change after repeated pressing, thereby providing reliable operation.

The present invention provides a pressure sensitive conductive sheet including a film-like base material and a resistive layer formed on the bottom surface of the base material, the resistive layer having soft particles and hard particles dispersed therein and different in average particle size from each other.

With this structure, a combination of elastically deformable soft particles and rigid hard particles dispersed in the resistive layer allows the pressure sensitive conductive sheet to have small variations in resistance change after repeated pressing, thereby allowing the sheet to provide reliable operation.

### BRIEF DESCRIPTION OF THE DRAWINGS

FIG. 1 is a sectional view of a panel switch according to a first embodiment of the present invention.

FIG. 2 is a sectional view showing a state in which the panel switch according to the first embodiment of the present invention is pressed.

FIG. 3 is a resistance characteristic diagram relative to the compressive force in the panel switch according to the first embodiment of the present invention.

FIG. 4 is a sectional view of another panel switch according to the first embodiment of the present invention.

FIG. 5A is a partial plan view of fixed contacts in the panel switch according to the first embodiment of the present invention.

FIG. 5B is a partial plan view of other fixed contacts in the panel switch according to the first embodiment of the present invention.

FIG. 5C is a partial plan view of other fixed contacts in the panel switch according to the first embodiment of the present invention.

FIG. 6 is a sectional view of a conventional panel switch.

FIG. 7 is a sectional view showing a state in which the conventional panel switch is pressed.

FIG. 8 is a resistance characteristic diagram relative to the compressive force in the conventional panel switch.

FIG. 9A is an enlarged sectional view showing a state in which the conventional panel switch has been repeatedly pressed.

FIG. 9B is another enlarged sectional view showing a state in which the conventional panel switch has been repeatedly pressed.

### DETAILED DESCRIPTION OF THE INVENTION

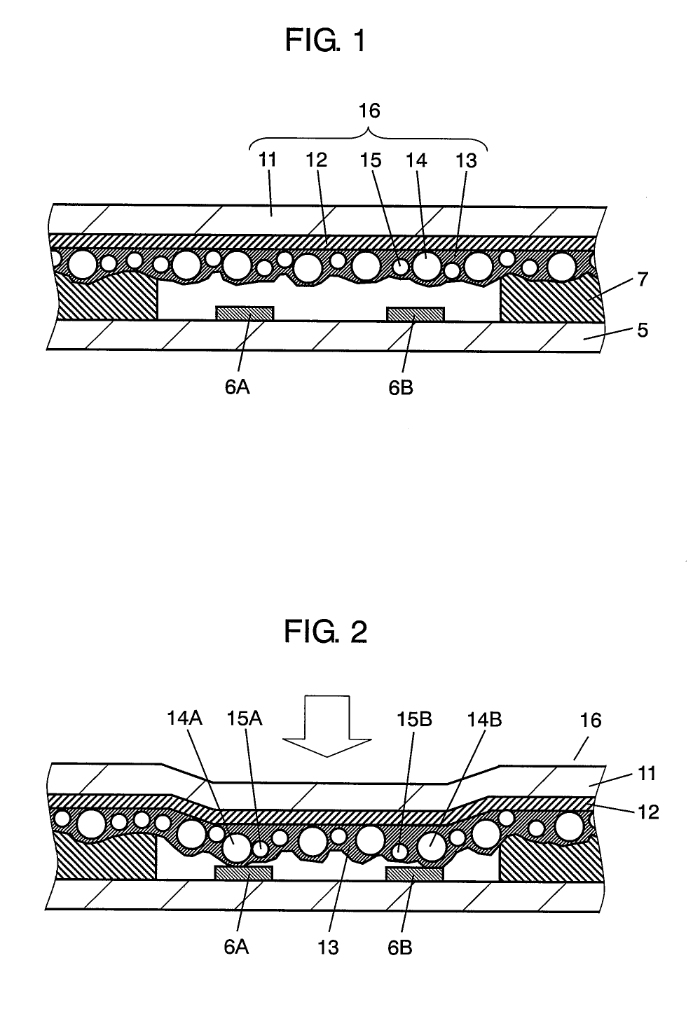

An embodiment of the present invention will be described as follows with reference to FIGS. 1 to 5. Of these drawings, the sectional views are exaggerated in the thickness direction for clarity. Like components are labeled with like reference numerals with respect to the panel switch described in the section of Background Art, and hence the detailed description thereof will be omitted.

### First Embodiment

FIG. 1 is a sectional view of a panel switch according to a first embodiment of the present invention. As shown in FIG. 1, the panel switch includes pressure sensitive conductive sheet 16 including base material 11, low resistive layer 12 on the bottom surface of base material 11, and high resistive layer 13 on the bottom surface of low resistive layer 12. Base material 11 is a flexible film with a thickness of 25 to 200 μm and made of polyethylene terephthalate, polycarbonate, polyimide, or the like. Low resistive layer 12 is made of a synthetic resin such as phenol with carbon powder dispersed therein, epoxy, phenoxy, or fluororubber, and has a sheet resistance of 50 Ω to 30 kΩ/square. Alternatively, low resistive layer 12 can be made of polyester or epoxy with silver, carbon, or the like dispersed therein, and have a sheet resistance of several ohms to several tens of ohms per square. Alternatively, the lower resistive layer than the low resistive layer 12 can be formed between base material 11 and the lower resistive layer 12, the lower resistive layer being made of polyester or epoxy with silver, carbon, or the like dispersed therein, and have a sheet resistance of several ohms to several tens of ohms per square.

High resistive layer 13 is made of a synthetic resin with carbon powder dispersed therein, and has a sheet resistance of 50 kΩ to 5 MΩ/square and a thickness of 1 to 50 μm. High resistive layer 13 contains soft particles 14 with a large average particle size and hard particles 15 with a small average particle size, both of the average particle sizes being in the range of 1 to 100 μm. Soft particles 14 are made of urethane, acrylic, nylon, silicone, olefin, or the like and have a Shore A hardness of 30 to 90. Hard particles 15 are made of glass, alumina, zirconia, or the like and have a Vickers hardness of 500 to 1800. Soft particles 14 and hard particles 15 are dispersed in an amount of 10 to 80 wt %, so that high resistive layer 13 has a rough bottom surface.

Pressure sensitive conductive sheet 16 having the above-described structure is formed as follows. First, low resistive layer 12 is screen printed on base material 11. Then, high resistive layer 13 having soft particles 14 and hard particles 15 dispersed therein is screen printed on low resistive layer 12 using an SUS plate with a 100 to 300 mesh size.

The panel switch also includes board 5 formed under the bottom surface of pressure sensitive conductive sheet 16. Board 5 can be a film made of polyethylene terephthalate, polycarbonate, or the like, or a plate made of paper phenol or glass-filled epoxy. Board 5 is provided thereon with fixed contacts 6A and 6B made of silver, carbon, copper foil, or the like with a spacing of 0.02 to 0.2 mm from each other under the bottom surface of pressure sensitive conductive sheet 16.

Between pressure sensitive conductive sheet 16 and board 5, there is provided spacer 7 made of an insulating resin such as polyester or epoxy in such a manner as to surround fixed contacts 6A and 6B. As a result, the bottom surface of high resistive layer 13 is opposite to fixed contacts 6A and 6B with a spacing of 10 to 100 μm therebetween.

The panel switch according to the first embodiment thus structured is installed on the control surface of an electronic apparatus, with fixed contacts 6A and 6B connected to electronic circuits (not shown) of the apparatus via lead wires (not shown) or the like.

FIG. 2 is a sectional view showing a state in which the panel switch according to the first embodiment is pressed. As shown in FIG. 2, when the user presses the top surface of pressure sensitive conductive sheet 16, pressure sensitive conductive sheet 16 bends downward, so that the portion of the bottom surface of high resistive layer 13 that has soft particles 14A and 14B with a large average particle size dispersed therein is brought into contact with fixed contacts 6A and 6B. As a result, fixed contacts 6A and 6B are electrically connected to each other via high resistive layer 13 and low resistive layer 12.

When the user applies a higher compressive force, the portion of the bottom surface of high resistive layer 13 that has hard particles 15A and 15B with a smaller average particle size than soft particles 14A and 14B is also brought into contact with fixed contacts 6A and 6B. This results in a change in the resistance between fixed contacts 6A and 6B.

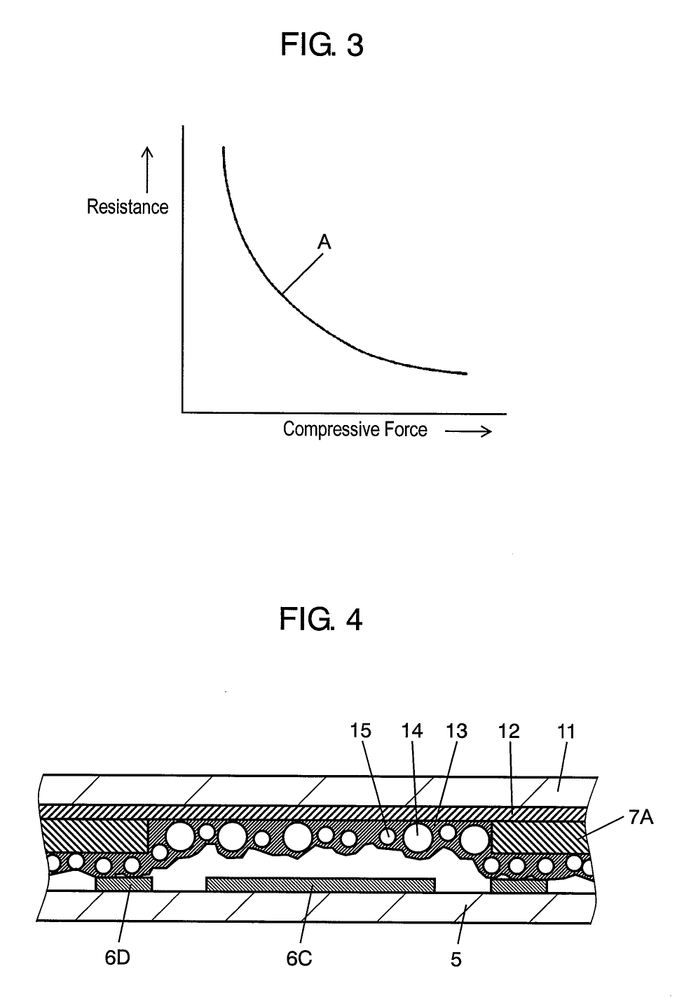

FIG. 3 is a resistance characteristic diagram relative to the compressive force in the panel switch according to the first embodiment. As shown in FIG. 3, as the compressive force increases, it increases the contact area between fixed contacts 6A, 6B and the bottom surface of high resistive layer 13, which is rough because high resistive layer 13 contains soft particles 14 and hard particles 15 different in average particle size. In other words, a compressive force produces a large resistance, and a large compressive force produces a small resistance. Thus, as shown in the curved line “A” of the resistance characteristic diagram of FIG. 3, the resistance characteristics gradually change according to the compressive force.

The electric connections or the resistance changed according to the compressive force are detected by an electronic circuit so as to perform various functions of the apparatus such as changing the speed of the cursor or the pointer on the display screen.

In the panel switch according to the first embodiment, pressing has been repeated hundreds of thousands or a million times, high resistive layer 13, which is brought into or out of contact with fixed contacts 6A and 6B, is prevented from being expanded and deformed or from having a flat bottom surface. This is because high resistive layer 13 has elastically deformable soft particles 14 and rigid hard particles 15 dispersed therein, which are different in average particle size. This results in small variations in the resistance between fixed contacts 6A and 6B.

As described above, the amount of dispersion of soft particles 14 and hard particles 15 in high resistive layer 13 can be selected within the range of 10 to 80 wt %. When the amount is less than 40 wt %, however, high resistive layer 13 has too large a surface area, whereas when it is over 60 wt %, soft particles 14 and hard particles 15 are closely packed in high resistive layer 13. Therefore, the amount of dispersion is preferably 40 to 60 wt % so that the particles 14 and 15 can be uniformly distributed across the surface of high resistive layer 13.

As described above, soft particles 14 can have a larger average particle size than hard particles 15 in order to mitigate the impact on high resistive layer 13 when pressed. This reduces the variations in the resistance change after repeated pressing, thereby allowing the panel switch to provide reliable operation.

The average particle sizes of soft particles 14 and hard particles 15 can be selected within the range of 1 to 100 μm as described above. However, it is preferably 1 to 30 μm in order to make particles 14 and 15 uniformly dispersed in high resistive layer 13 having a thickness of 1 to 50 μm. It is further preferable to combine hard particles 15 with an average particle size of 5 to 15 μm and soft particles 14 with an average particle size of 10 to 25 μm.

The ratio of soft particles 14 to hard particles 15 in high resistive layer 13 can be selected within the range of 1:9 to 9:1. It is preferable, however, that hard particles 15 are more dispersed when soft particles 14 have a large average particle size, and less dispersed when soft particles 14 have a small average particle size.

Alternatively, the present invention can be implemented without using low resistive layer 12 by directly forming high resistive layer 13 having soft particles 14 and hard particles 15 dispersed therein on the bottom surface of base material 11. As described above, however, forming low resistive layer 12 and high resistive layer 13 in this order on the bottom surface of base material 11 makes the resistance change smooth and stable. More specifically, as shown in FIG. 2, when the compressive force is small enough that only the bottom surface of high resistive layer 13 beneath soft particles 14A and 14B having a large average particle size comes into contact with fixed contacts 6A and 6B, the resistance between fixed contacts 6A and 6B is the sum of the resistance of high resistive layer 13 between soft particles 14A and 14B, and the conductor resistance of low resistive layer 12.

On the other hand, when the compressive force is high enough that the bottom surface of high resistive layer 13 beneath hard particles 15A and 15B having a small average particle size comes into contact with fixed contacts 6A and 6B, the sum of the conductor resistances between hard particles 15A and 15B is added in parallel to the sum of the resistance of high resistive layer 13 and the conductor resistance of low resistive layer 12. As a result, the resistance between fixed contacts 6A and 6B is small.

Thus, as the contact area increases between the rough bottom surface of high resistive layer 13 and fixed contacts 6A, 6B with increasing compressive force, the sum of the resistance of high resistive layer 13 and the conductor resistance of low resistive layer 12 having different sheet resistances from each other between fixed contacts 6A and 6B continues to be added in parallel. As a result, as shown in the curved line “A” of the resistance characteristic diagram of FIG. 3, the resistance change can be smooth and stable. Alternatively, by setting the lower resistive layer than the low resistive layer 12 between base material 11 and the lower resistive layer 12, the three-layered structure can be formed, and it makes the resistance change smoother and more stable.

In the above description, low resistive layer 12 has a sheet resistance of 50 Ω to 30 kΩ/square, and high resistive layer 13 has a sheet resistance of 50 kΩ to 5 MΩ/square. It is preferable, however, that low resistive layer 12 has a sheet resistance of 50 Ω to 10 kΩ/square, and high resistive layer 13 has a sheet resistance of 100 kΩ to 1 MΩ/square.

FIG. 4 is a sectional view of another panel switch according to the first embodiment. As shown in FIG. 4, low resistive layer 12 formed on the bottom surface of base material 11 is provided at the outer periphery of the center of its bottom surface with spacer 7A. High resistive layer 13 having soft particles 14 and hard particles 15 dispersed therein is formed on the center of the bottom surface of low resistive layer 12 and on the bottom surface of spacer 7A. Board 5 is provided with circular fixed contact 6C in the center of its top surface, and substantially ring- or horseshoe-shaped fixed contact 6D on the outer periphery of the top surface.

The portion of high resistive layer 13 that is formed on the bottom surface of spacer 7A is placed on or adhesively connected to fixed contact 6D. The center of the bottom surface of high resistive layer 13 faces fixed contact 6C. The panel switch thus structured provides the same effect as the panel switch of FIG. 1.

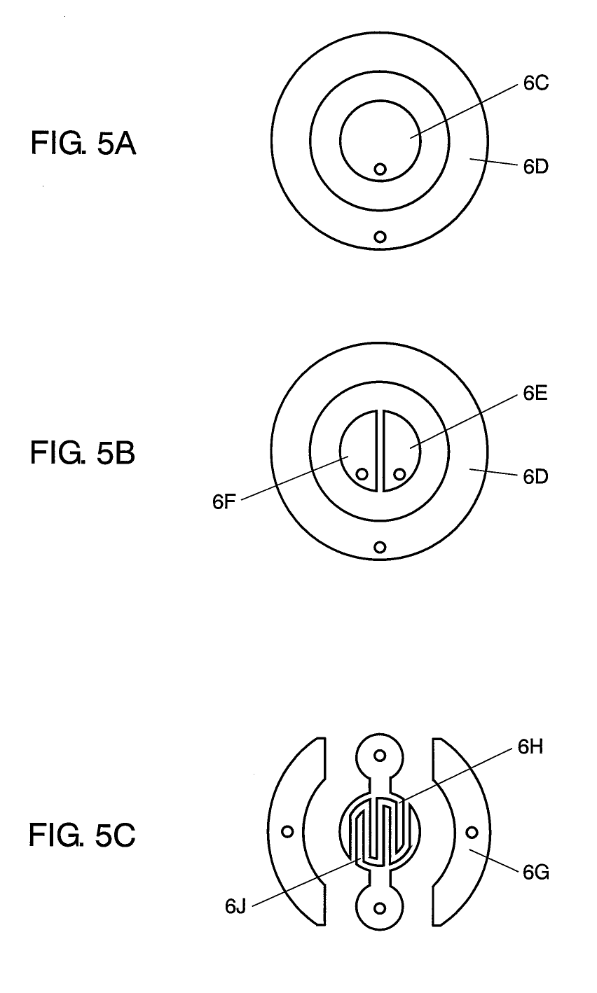

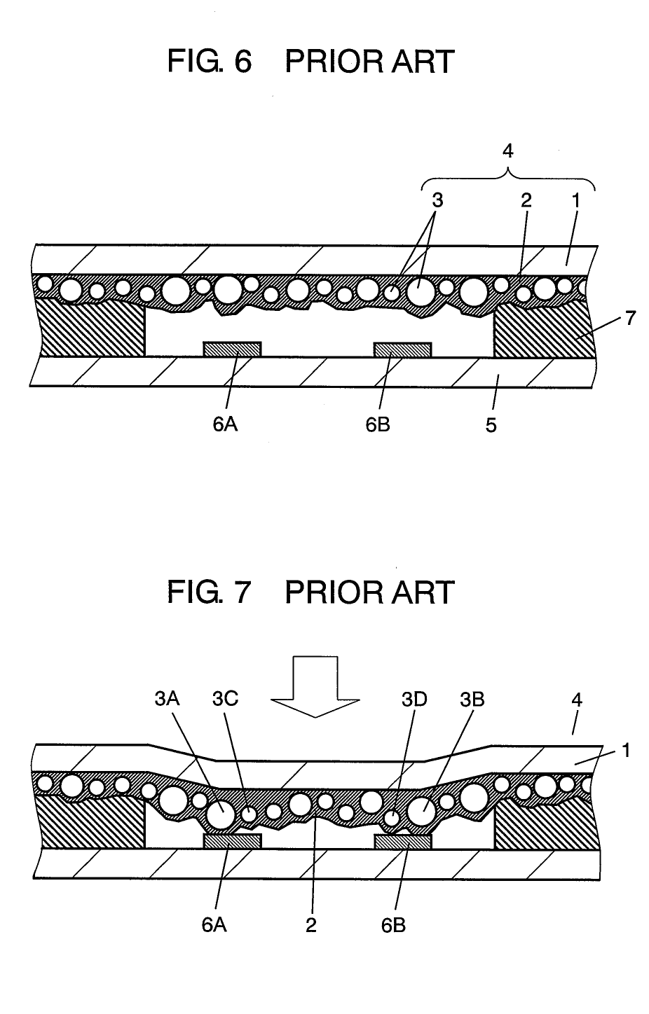

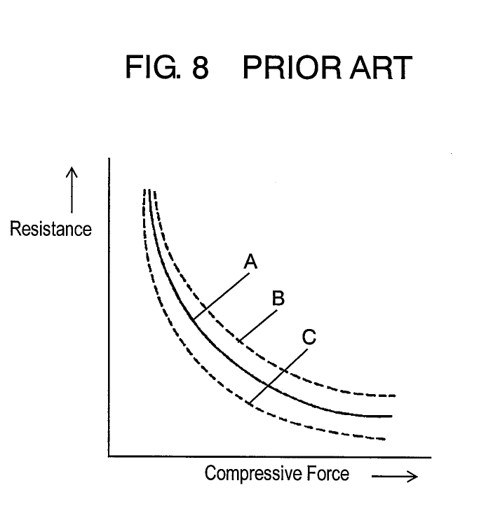

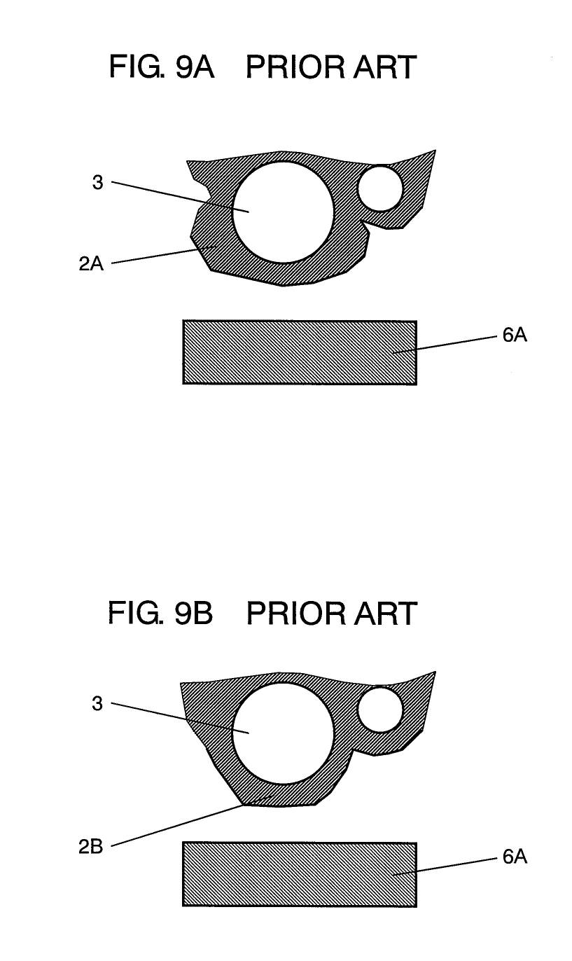

The panel switch according to the present invention provides other various shaped fixed contacts. FIGS. 5A to 5C are partial plan views of fixed contacts used in the panel switch according to the first embodiment. In FIG. 5A, circular fixed contact 6C and annular fixed contact 6D are concentrically arranged with respect to each other. In FIG. 5B, fixed contacts 6E and 6F are semicircular. In FIG. 5C, comb-shaped fixed contacts 6H and 6J are engaged with each other between two arc-shaped fixed contacts 6G.

As described hereinbefore, according to the present embodiment, low resistive layer 12 and high resistive layer 13 are formed in this order on the bottom surface of film-like base material 11, and soft particles 14 and hard particles 15 different in average particle size are dispersed in high resistive layer 13. Fixed contacts 6A and 6B are arranged under the bottom surface of high resistive layer 13. This structure provides pressure sensitive conductive sheet 16 and a panel switch using the sheet, which have small variations in the resistance change after repeated pressing, thereby providing reliable operation.

The pressure sensitive conductive sheet and the panel switch using the sheet according to the present invention are useful for the operation of various electronic apparatuses because of having small variations in the resistance change and providing reliable operation.

What is claimed is:

1. A pressure sensitive conductive sheet comprising:
a film-like base material; and
a resistive layer formed on a bottom surface of the base material, the resistive layer having soft particles and hard particles dispersed therein, the soft particles and the hard particles being different in average particle size from each other.

2. The pressure sensitive conductive sheet of claim 1, wherein
the soft particles have a larger average particle size than the hard particles.

3. The pressure sensitive conductive sheet of claim 1, wherein
the resistive layer comprises:
a low resistive layer formed on the bottom surface of the base material; and
a high resistive layer formed on a bottom surface of the low resistive layer, the high resistive layer having the soft particles and the hard particles dispersed therein.

4. A panel switch comprising:
the pressure sensitive conductive sheet of claim 1; and
a plurality of fixed contacts arranged under the bottom surface of the resistive layer.
